(19) United States
(12) Patent Application Publication
(10) Pub. No.: US 2003/0212480 A1
(43) Pub. Date: Nov. 13, 2003

(54) Method and apparatus for controlling operations in a vehicle

(75) Inventors: Robert Pierce Lutter, Tacoma, WA (US); Tracy Olson, Auburn, WA (US)

Correspondence Address: MARGER JOHNSON & McCOLLOM, P.C., 1030 S.W. Morris Street, Portland, MO, 97205, US

(73) Assignee: Medius, Inc., Seattle, WA (US)

(21) Appl. No.: 10/143,074

(22) Filed: May 10, 2002

(51) Int. Cl. G06F 19/00

(52) U.S. Cl. 701/33; 340/436

(57) ABSTRACT

A mission control unit includes a collision detection sensor and a processor. The processor initiates different collision detection events when a collision condition is indicated by the collision detection sensor. The mission control unit can be coupled to a vehicle wiring harness to provide real-time engine diagnostics while the vehicle is being driven. The mission control unit also automatically establishes a wireless communications link to a call center during a collision condition and allows the call center to remotely control and monitor devices in the vehicle. In another aspect of the invention, an image sensor is used to verify the driver as an authorized vehicle operator.

### BACKGROUND OF THE INVENTION

Cars and other vehicles have wiring harnesses that control different devices in the car. The wiring harness may include a signal that indicates when the oil level is low and another signal that indicates the water temperature in the radiator. Other signals in the wiring harness are coupled to computers and other sensors that indicate if different devices, such as a fuel injection system or a catalytic converter are operating correctly.

The problem is that many of these signals either don't sufficiently notify the car operator of current operating conditions. For example, the oil level indicator signal activates a light on a vehicle dashboard when the oil is below a predetermined level. However, there is not indication of how many miles the vehicle has been driven using the same oil or how much longer the car should be driven using the same oil. For example, there is no indication whether the car was being driven under extreme temperatures, in city traffic, or in highway traffic. Since oil replacement depends on many different factors including temperature, time, and mileage, simply indicating when the oil level is low is insufficient for determining oil conditions.

Many of the signals in the wiring harness are only accessible through a diagnostics analyzer that is located at a car service center. A service technician plugs the diagnostics analyzer into a wiring harness port in the car and then reads different signals from the wiring harness to determine if the car is operating correctly. However, by the time a vehicle it taken to the service center, the vehicle may already be permanently damaged.

Some vehicles have emergency call systems that allow a car operator to contact a call center during an emergency. Some emergency call systems include a Global Positioning System (GPS) that provides the call center with vehicle location information. However, these emergency call systems require the car operator to manually activate a button to initiate the emergency call. If the car operator is incapacitated, no emergency signal will be transmitted at all or, the call center may not be able to determine the severity of the accident.

The present invention addresses this and other problems associated with the prior art.

### SUMMARY OF THE INVENTION

A mission control unit includes a collision detection sensor and a processor. The processor initiates different collision detection events when a collision condition is indicated by the collision detection sensor. The mission control unit can be coupled to a vehicle wiring harness to provide real-time engine diagnostics while the vehicle is being driven. The mission control unit also automatically establishes a wireless communications link to a call center during a collision condition and allows the call center to remotely control and monitor devices in the vehicle. In another aspect of the invention, an image sensor is used to verify the driver as an authorized vehicle operator.

The foregoing and other objects, features and advantages of the invention will become more readily apparent from the following detailed description of a preferred embodiment of the invention which proceeds with reference to the accompanying drawings.

### BRIEF DESCRIPTION OF THE DRAWINGS

FIG. 1 is a schematic diagram of the Mission Control Unit (MCU).

FIG. 2 is a diagram showing examples of where the MCU may be installed in a vehicle.

FIG. 3 is a detailed block diagram of the MCU.

FIG. 4 is a schematic diagram showing how the MCU operates during a collision condition.

FIG. 5 is a block diagram showing how different devices in a vehicle are enabled or disabled during the collision condition.

FIG. 6 is a schematic diagram showing how the MCU is coupled to a wiring harness interface.

FIG. 7 is a block diagram showing how the MCU provides diagnostics in real-time during car operation.

FIG. 8 is a schematic diagram showing how an image sensor is used to verify authorized car operators.

FIG. 9 is a flow diagram showing how the image sensor in FIG. 8 is used for customizing car parameters for authorized car operators.

FIG. 10 is a flow diagram showing how the image sensor can be used to control door and trunk locks.

### DETAILED DESCRIPTION

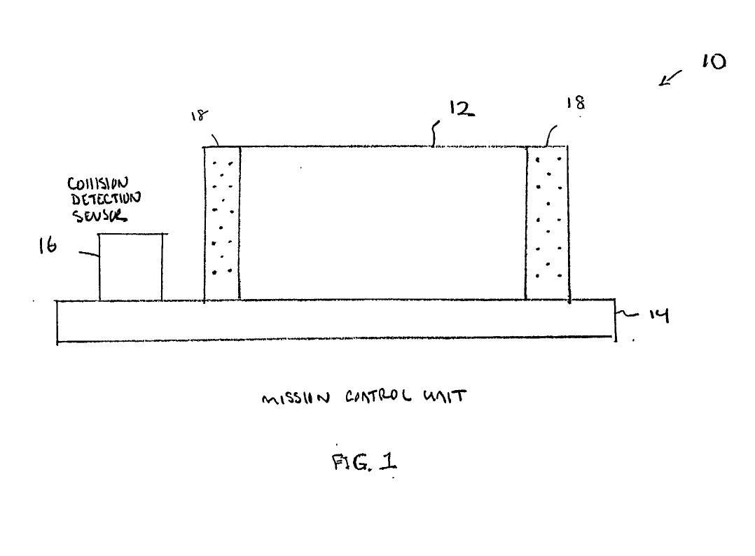

FIG. 1 shows a Mission Control Unit (MCU) 10 that includes a computer 12 that processes different types of vehicle data. A metal base 14 supports the computer 12 and a Collision Detection Sensor (CDS) 16. The metal base 14 provides a common planar reference for both the computer 12 and the CDS 16. The CDS 16 measures Gravity (G) forces that are experienced by a vehicle that contains the MCU 10. In one embodiment, the CDS 16 is settable to activate a signal at some force between 5 and 40 Gs. Collision detection sensors are know to those skilled in the art and are therefore not described in further detail.

There may be a rubber pad (not shown) between the computer 12 and the metal plate 14. However, the CDS 16 is rigidly attached to the metal plate 14 and the metal plate 14 is rigidly bolted to a vehicle. For example, the metal plate 14 can be bolted to the vehicle chassis or some other structural member of the vehicle. This allows any G forces experienced by the vehicle to also be sensed by the CDS 16.

Microphones in audio units 18 allow a vehicle operator to transmit audio signals over a wireless communications channel to another location. The audio units 18 also include speakers for receiving audio signals from a vehicle audio system or outputting audio signals received over the wireless communication channel, such as over a cellular communication 110 system. The speakers in the audio units 18 can also output 3-D audio signals for annunciating collision conditions to the vehicle operator. The 3-D audio signals are described in co-pending patent application entitled: Method and Apparatus for Managing Audio Devices, Ser. No. 09/892,295 which is herein incorporated by reference.

The mission control unit 10, among other things, provides remote door lock control, real-time vehicle diagnostics, emergency notification, collision notification, and wireless audio and data communications. In general, the mission control 10 can control any device located in a vehicle, store information for any device in the vehicle and communicate that information to a remote system. The mission control unit 10 is portable so that it can be installed after market in different vehicles and in different locations in the vehicles. Because the MCU 10 is portable, it can be periodically removed from a vehicle for upgrading and adding new functions.

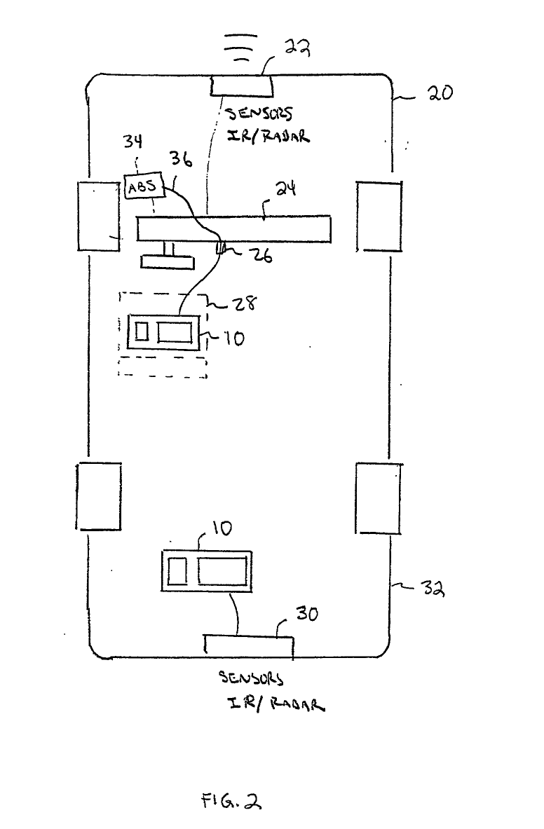

FIG. 2 shows different locations where the MCU 10 can be mounted inside a vehicle 20. In one embodiment, the MCU 10 is located either underneath a driver seat 28 or in a back trunk 32 of the vehicle 20. Of course, the MCU 10 can be located in other places in the vehicle. By locating the CDS 16 in an interior location in the vehicle 20, collision conditions can be more accurately detected.

Collision detection sensors used for activating airbags are located in the front or sides of the vehicle at locations where collisions may occur with external objects. However, the vehicle 20 could roll over or stop suddenly without ever colliding with another vehicle or another object. The externally located collision detection sensors therefore may not detect certain collision conditions.

Conversely, the CDS 16 is located in an interior location of the vehicle 20 to more accurately detect any external force received by the vehicle 20. The CDS 16 is also configured to activate whenever there is a certain rate of rotational change about the central axis of the vehicle. This allows detection of a wider variety of different collision conditions. The CDS 16 is also configured to activate when a certain threshold G force is detected. The MCU 10 continuously records the different G forces recorded by the CDS 16 and can be downloaded later for accident reconstruction.

In another application, the MCU 10 includes one or more video or other IR or radar sensors that can capture images around the vehicle. If a certain threshold G force is detected by the CDS 16, the MCU 10 automatically activates the image sensors. This allows the sensors to identify any other car or object that may have bumped the vehicle even when the operator is not operating the vehicle.

The MCU 10 is coupled to a Wiring Harness Interface (WHI) 26 that taps into the vehicles wiring harness 36. The wiring harness 36 contains electrical wires that control or monitor the performance for different devices in the vehicle 20. For example, the wiring harness 36 includes wires that control and/or monitor an Automatic Brake System (ABS) 34, automatic door locks, speedometer, tachometer, oil level, water temperature, etc. Typically the tap 26 for interfacing with the wiring harness 36 is located underneath a dash board 24. However, the wiring harness tap can be located anywhere in vehicle 20.

The wiring harness interface 26 can connect to a CAN, J1850, or ODB2 bus connections for communicating with critical vehicle buses. Diagnositcs data is extracted for prognostic health management and trend analysis and to input vehicle commands to critical vehicle processors. Critical vehicle processors include Automatic Braking System (ABS), Engine Control Unit (ECU) or Body Control Unit (BCU) to name a few. The wiring harness interface 26 allows control of vehicle functions such as door locks, automatic braking, throttle control and audio system control. The wiring harness interface 26 also provides a firewall between mission functions and vehicle drive critical functions.

The MCU 10 also has other interfaces for coupling to other Original Equipment Manufacture (OEM) devices or other after market devices, such as Infrared (IR) and/or Radar sensors 22 and 30. The MCU 10 includes relays for controlling power to different electrical mechanical devices. The MCU 10 also includes network or bus interfaces for sending commands that control processor based devices. Thus, device in the vehicle 20 can be monitored and controlled both through the vehicle wiring harness 36 and through other interfaces located directly on the MCU 20. For example, a wireless interface can be used that allows communication with a vehicle maintenance device in a garage.

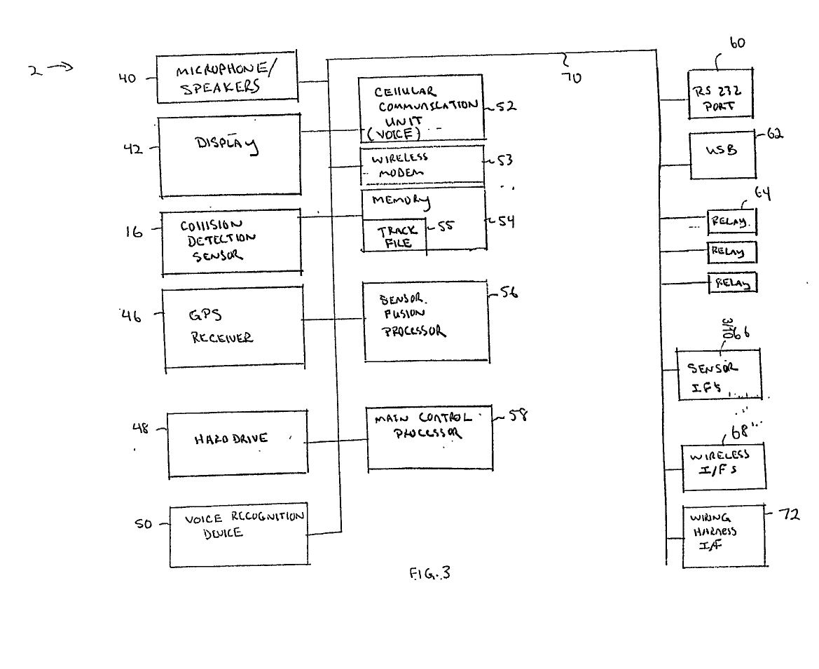

One of the operations that can be performed by the MCU 10 is to automatically control the ABS system 34 and audio systems according to objects detected by the sensors 22 and 30. The sensors 22 and 30 monitor different areas around the vehicle 20. The MCU 10 determines the kinematic state of the vehicle 20 by reading a speed value from the vehicle wiring cable 36 and vehicle direction from an internal GPS receiver 46 (FIG. 3). The MCU 10 determines the kinematic state for any external objects coming within a particular range of the vehicle 20 via the sensors 22 and 30.

In a first range, the MCU 10 may output an audible warning signal through the speakers in audio device 18 (FIG. 1) or output the warning signal through the wiring harness 36 to the vehicle speakers. In a second closer range, the MCU 10 may detect objects having a kinematic state on a collision course with vehicle 20. In this second range, the MCU 10 may automatically activate the ABS system 34 through the wiring harness 36. The MCU 10 can also display through an onscreen display either on the dashboard 24 or on a MCU display 42 (FIG. 3) a direction to turn the vehicle 20 in order to avoid a collision with the detected object. In another embodiment, the MCU 10 automatically steers the vehicle 20 to avoid a collision with the detected object.

FIG. 3 shows the functional elements in the computer 12 of the MCU 10. One or more busses 70 couple the different functional elements of the computer 12 together. In one embodiment, the bus 70 is a Peripheral Component Interface (PCI) bus. Microphones and speakers 40 are used to generate audio warnings as described above as well as output audio signals from different audio devices such as a Compact Disc (CD) player, radio, etc. The speakers can also be used to output a voice signal received via a wireless cellular communication unit 52. A microphone in unit 40 can pickup audio signals from persons in the vehicle 20 (FIG. 2) which are then transmitted over a wireless communication link established by the cellular communication unit 52. The same cellular communication unit 52 or a separate wireless modem 53 can be used for transmitting data over a wireless link.

A display 42 can be either an alphanumeric display or a graphical user interface that displays control icons as well as vehicle parameter information to the user. The display 42 can output control and data information from any of the devices in the computer 12 such as G force readings from the collision detection sensor 44, location data from a GPS receiver 46, phone numbers from memory 54 for making calls through the cellular communication unit 52, etc. The GPS receiver 46 is used for identifying location, direction, and other kinematic state information for the vehicle 20.

A hard drive 48 is used for storing system boot-up and configuration data as well as storing vehicle historical data such as previous driving locations, distances, speeds, engine temperatures, miles since last oil change, etc. The hard drive 48 can also store object profiles that may be used by a sensor fusion processor 56 for identifying different types of objects and different vehicle operators. Electronic maps can be stored in the hard drive 48 for using in conjunction with GPS data from GPS receiver 46 for identifying street locations for vehicle 20.

A voice recognition device 50 is used for converting the audio signals of the vehicle operator into digital data that can then be used by a main control processor 58 for performing different operations. For example, the vehicle operator may say the following: “phone Pierce”. The audio signals are converted into electrical signals by the microphone 40, converted into digital data by the voice recognition device 50, and then sent to the main control processor 58. The processor 58 is preprogrammed to automatically establish a cellular communication link via cellular communication unit 52 whenever the command “phone” is received.

The processor 58 first accesses a phone directory saved in hard drive 48 for any phone number associated with the name “Pierce”. If a match is identified, then the main control processor 58 automatically dials up the identified number through the cellular communication unit 52. After the cellular link is established through the cellular communication unit 52, audio signals for the cellular call are output and received through the microphone and speakers 40.

The memory 54 is used for temporary storage of configuration data for the MCU 12 as well as storing any vehicle parameters that need to be accessed quickly. Memory 54 may be any combination of Dynamic Random Access Memory (DRAM), Flash Memory, Static Random Access Memory (SRAM), etc. The memory 54 may contain a track file 55 containing kinamatic state information for the vehicle 20 for some previous period of time. The kinematic state of the vehicle 20 is compared with the kinematic state for different objects detected by the vehicle sensors 22 and 30 (FIG. 2). Past kinematic state data for the vehicle 20 that extends back more than some predetermined period of time is moved from the memory 54 to the hard drive 48.

A sensor fusion processor 56 is used for processing and fusing the sensor data received by the sensors 22 and 30 (FIG. 2). The sensor fusion processor 56 identifies different objects by comparing the sensor data with stored image templates for different predetermined objects. The sensor fusion processor 56 also determines kinematic states for detected objects and compares those kinematic states with the kinematic state of the vehicle 20. The sensor fusion processor 56 can receive object data from any variety of IR, radar and video sensors on the vehicle 20 and on other vehicles in the vicinity of vehicle 20.

A collision condition is defined as a potential collision between the vehicle 20 and any object detected outside of the vehicle. Any collision condition determined in sensor fusion processor 56 is sent to the main processor 58. The processor 58 then activates the appropriate devices coupled to the computer 12. For example, the processor 58 may show the collision condition on the display 42, activate a warning signal from speakers 40, and/or send a break command to a breaking system controller coupled to one of the interfaces 60, 62, 64, 66, 68 or 72.

Multiple relays 64 are used to control vehicle components that are not controllable either through the wiring harness interface 72, a wireless interface 68 or serial network interfaces 60 or 62. For example, the relays 64 may be coupled to a battery cable used for controlling power to door locks. In another example, the door locks are controlled through the wiring harness. The processor 58 then controls the door locks through interface 72.

A RS-232 serial interface 60 and/or a Universal Serial Bus (USB) interface 62 can also be used for transferring commands between the computer 12 and different vehicle components. Any network or bus interface can be coupled to the computer 12. A wireless interface 68 allows data to be transferred wirelessly between the computer 12 and different portable or built-in vehicle devices. The wireless interface 68 in one example is a blue tooth or 802.11 wireless interface. Sensor interfaces 66 transfer data with the sensors 22 and 30 previously shown in FIG. 2.

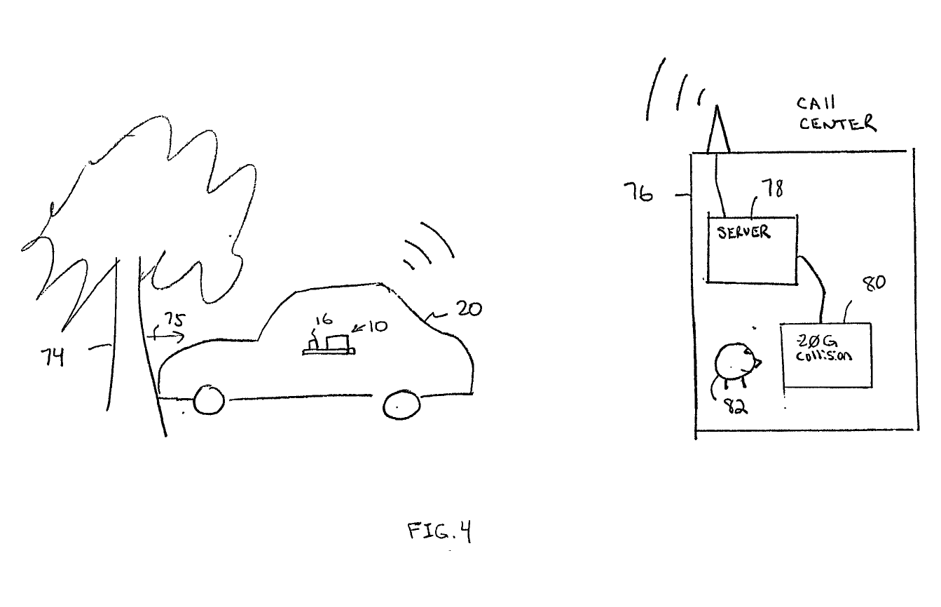

FIG. 4 shows one example of how the MCU 10 is used for notifying a call center 76 of an accident. The CDS 16 detects a G force 75 resulting from a collision between the vehicle 20 and a tree 74. The main control processor 58 (FIG. 3) determines from the G force reading from the CDS 16 that the collision qualifies as an emergency condition. An emergency condition may be identified as any G force above some threshold value or any G forces indicating the vehicle 20 has rolled partially or completely over.

The main control processor 58 directs the cellular communication unit 52 to automatically phone the call center 76. The cellular communication unit 52 establishes a wireless communications link with the call center 76. The operator of the vehicle 20 can then talk through the microphone 40 and cellular communications unit 52 to an operator 82 at the call center 76. The vehicle operator can tell the call center operator 82 if there is any need for emergency assistance. The call center operator 82 can also ask the vehicle operator if an emergency situation exists. If there is no response to the request, the call center operator 82 can send out an emergency response vehicle to the location of the vehicle 20.

The location of the vehicle 20 is periodically recorded by the GPS receiver 46 and is automatically sent to the call center 76 after a collision condition is determined by the processor 58. The vehicle location can be sent to the call center 76 in any one of a variety of different ways. In one embodiment, digital data identifying the location of vehicle 20 is read from the GPS receiver 46 by the processor 58. The processor 58 then feeds the location data into the voice recognition device 50 that converts the digital data into audio signals that are then output over the voice channel established by the cellular communication unit 52. The call center operator 80 then hears the audio location over a user interface 80.

In another embodiment, the digital location data is read from the GPS receiver 46 by the processor 58 and then transmitted over a separate data channel established by the cellular communication unit 52. In another embodiment, the digital location data is sent over a separate wireless channel established by a wireless modem 53 after the collision condition is determined by the processor 58. The location data is received by a server 78 that saves the digital location data and then displays the location data on the user interface 80. The location data may be immediately relayed to an emergency response unit, such as a fire station, or may be relayed after the call center operator 82 verifies an emergency condition by attempting to audibly contact the vehicle operator over the audio channel established by the cellular communication unit 52.

The main control processor 58 can transmit other diagnostic information to the call center 76. For example, the processor 58 can automatically send the G force value determined by the CDS 16 and the speed history of the vehicle 20 over a predetermined time period.

The Voice Recognition System (VRS) 50 also allows a user to control the MCU 10 simply by speaking into the microphone 40. The VRS 50 converts the audio signals into digital data that is then used to control the main control processor 58. For example, the user can simply say “emergency”. The VRS 50 converts the voice signals into digital data that is then received by the main control processor 58. In response to the “emergency” command, the processor 58 makes a cellular call to the call center 76. The driver then either converses with the call center operator 82 or the call center determines on its own that the call was initiated pursuant to an emergency request.

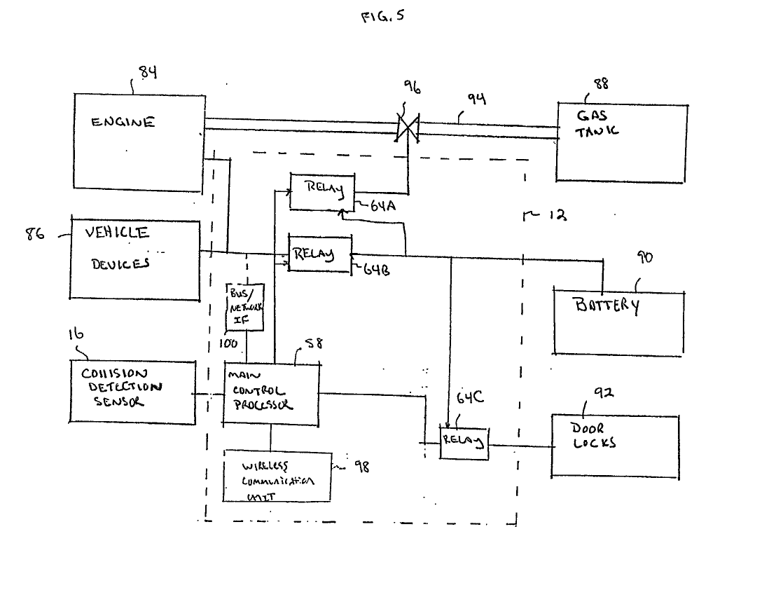

FIG. 5 shows one example of how the MCU 10 is used to automatically activate different devices in the vehicle 20 either locally by the main control processor 58 or remotely by signals sent by the call center 76 (FIG. 4). A vehicle includes an engine 84 that receives gas from a gas tank 88 through a gas line 94. The vehicle also includes a battery 90, door locks 92 and other vehicle electrically controlled devices 86.

An electrically operated valve 96 is coupled to a battery power supply 90 through relay 64A. The door locks are supplied power from battery 90 through a relay 64C and the other electrical devices 86 in the vehicle are coupled to battery 90 through relay 64B. Each of the relays 64A, 64B and 64C are controlled by the main control processor 58. Alternatively, the main control processor may control any combination of the vehicle electrical devices through a bus or network interface 100.

The main control processor 58 receives wireless signals from a wireless communication unit 98. The wireless unit 98 can be the cellular communication unit 52 or the wireless modem 53 shown in FIG. 3 or some other wireless device that can transmit and receive data, such as a wireless satellite transceiver or a wireless blue tooth or 802.11 interface.

A certain G force is detected by the CDS 16 and sent to the main control processor 58. The processor 58 determines from the G force reading that a collision condition exits. The main control processor in one example then automatically opens the door locks 92 by activating relay 64C so that emergency personnel can access the driver in the vehicle. The main control processor 58 can also automatically disconnect the battery from certain vehicle electrical devices 86 by activating relay 64B. The processor 58 can also disconnect the gas tank 88 from the engine 84 by activating relay 64A. This may prevent the vehicle from catching fire after the collision condition is detected.

In an alternative embodiment, the different relays are activated only after a signal is received from the call center 76 (FIG. 4). This allows the call center operator 82 to first try and communicate with the vehicle operator before disabling any devices in the vehicle 20. The signal from the call center 76 is received by the wireless communication unit 98 and sent to the main control processor 58. The main control processor 58 then activates relays 64A, 64B, and 64C. Or selectively activates only the relays for specific devices identified by the call center 76.

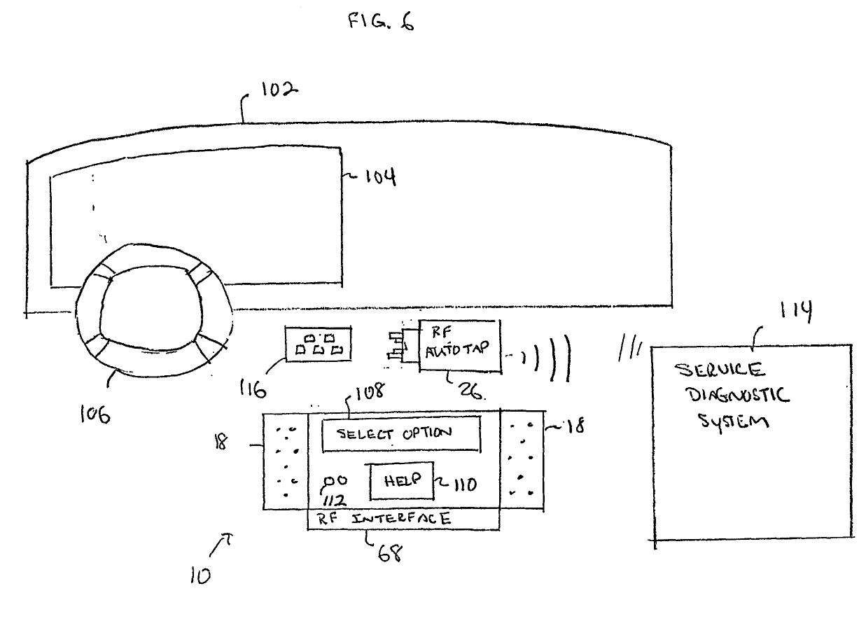

FIG. 6 shows the interior of a vehicle. The dashboard 102 of the vehicle includes a user configurable screen display 104. The wiring harness 116 is coupled to a RF autotap 26.

In one example the RF autotap is a J1850 wireless unit. The autotap 26 plugs into a Common Area Network (CAN) bus or an Onboard Diagnostics bus. The autotap 26 allows any of the parameters on the wiring harness to be output to the MCU 10.

The autotap 26 wirelessly transmits signals from the wiring harness 116 to an RF interface 68 in the MCU 10. The MCU 10 in this example is located in a front console area in the vehicle between the front seats. In an alternative embodiment, the MCU 10 is connected by a cable to the wiring harness 116. The autotap 26 allows the MCU 10 to monitor, record and identify the vehicle operator of vehicle performance real-time while the car is being driven. This allows the MCU 10 to identify potential vehicle problems before they happen. For example, miscalibrated engine timing, overdue oil replacement or other device replacement, etc.

When an accident occurs, a vehicle operator may manually send an emergency signal to the call center 76 by pressing help button 110. The MCU 10 then automatically establishes a cellular call with the call center using the cellular communication unit 52 shown in FIG. 3. The call center operator can then converse with the vehicle operator through the speaker/microphone units 18. The call center 76 can also read any of the signals from the wiring harness 116 or for remotely control vehicle devices by sending control signals to the MCU 10.

For example, the driver may be having car trouble, but does not know the cause of the trouble. The call center operator 82 can read signals from the wiring harness 11 in order to determine the cause of the problem. This is conducted by sending a request to the MCU 10 for a particular parameter. The MCU 10 then reads the parameter from the wiring harness 116 or from some other device connected to the MCU 10. If the problem can be corrected remotely, the call center operator can send the necessary signals to the MCU 10 which then forward the signals through the wiring harness 116 to the device causing the problem.

The MCU 10 includes a display 108 that allows a user to select what signals are displayed on the display 108 or on the dashboard display 104. A user can reconfigure where and what vehicle parameters are displayed on screen 104. For example, the operator may not care to see the RPMs of the engine, but may want to see vehicle speed and any images detected from the sensors 22 and 30. The operator selects the speed signal and sensor data from a menu presented on the MCU display 108.

The MCU 10 taps into the wiring harness 116 to obtain vehicle speed data. The speed data is then directed back through another wire on the wiring harness 116 that is coupled to the dashboard screen 104. The MCU 10 also outputs image data from the sensor fusion processor 56 through the wiring harness 16 to the dash screen 104. If the driver does not like where the speedometer data is located on the screen 104, the location can be moved either through the MCU 10 or through a user drag and drop interface on the screen 104.

The RF autotap 26 is accessed either by the MCU 10 or by other devices such as a service diagnostics system 114. The diagnostics system 114 has a wireless interface that either communicates directly with the RF autotap 26 or communicates to the RF autotap 26 through the MCU 10. This allows service centers to analyze car performance remotely from a service room without having to manually connect the diagnostic system 114 to the wiring harness 116.

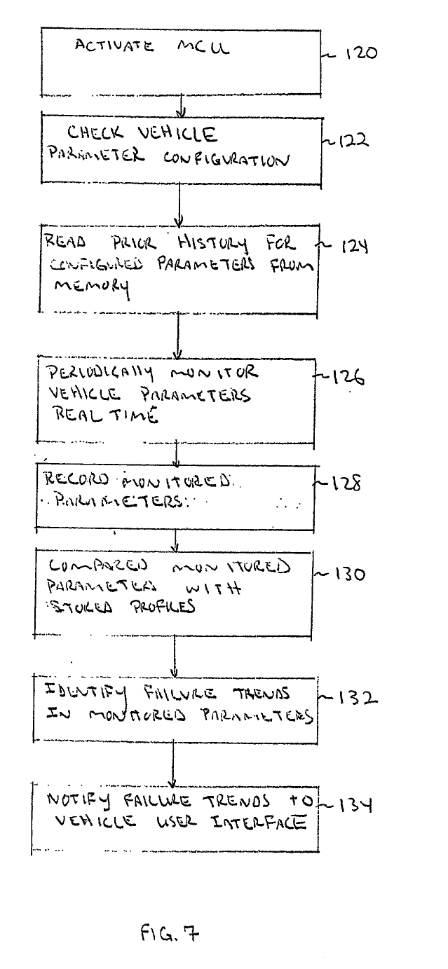

FIG. 7 shows one example of how the MCU 10 performs diagnostics. The MCU 10 is activated in block 120. This is typically done when the vehicle is powered on. However, some MCU operations may be continuously performed even when the vehicle is turned off. For example, the MCU 10 may automatically activate the sensors 22 and 30 whenever the collision detection sensor 16 detects a minimum G force on the vehicle. The MCU 10 can also detect signals from wireless devices that may automatically activate certain functions even when the vehicle is turned off.

The MCU 10 in block 122 checks to see what parameters are configured for real time diagnostic evaluation. For example, either the vehicle operator or a technician preselects a set of vehicle parameters, such as oil pressure, water temperature, brake pads, engine temperature, etc. The MCU in block 124 reads any prior history for the configured parameters from memory. For example, the diagnostic history for the oil temperature may track how many miles its been since the oil has been changed, a history of the temperatures of the oil and how many miles the current oil has been used and at what temperatures. By tracking the oil temperature in over time and miles, the MCU can more accurately determine when the oil should be changed.

In block 126 the MCU periodically monitors the vehicle parameters, such as mileage and oil temperature and records the monitored parameters in block 128. The stored parameters are compared with stored parameter profiles in block 130. For example, the oil profile may simply be a table that indicates replacement thresholds for different mileage and temperature combinations. The oil profile may recommend oil replacement at 5,000 miles when the average oil temperature is 200 degrees. However, the oil profile may recommend oil replacement at 3,000 miles when the average oil temperature over those 3,000 miles is 300 degrees. The MCU in block 132 identifies any failure trends or replacement indications based on the comparison between the stored parameters and the parameter profiles. The MCU notifies the vehicle operator of the failure or replacement recommendation in block 134.

The MCU 10 stores parameter operating history and continues to check and update the parameter operating history in real-time during the operation of the vehicle. The MCU tracks the exact conditions that the device operated under for the tracked mileage, such as the temperature, oil level, stop and go mileage, highway mileage, etc. This allows the MCU to more accurately determine when parameters in the vehicle have failed or when parameters should be replaced. Because the MCU immediately notifies the vehicle operator of failures and replacement recommendations, there is less chance that the vehicle will be damaged by using vehicle components past their recommended operating life.

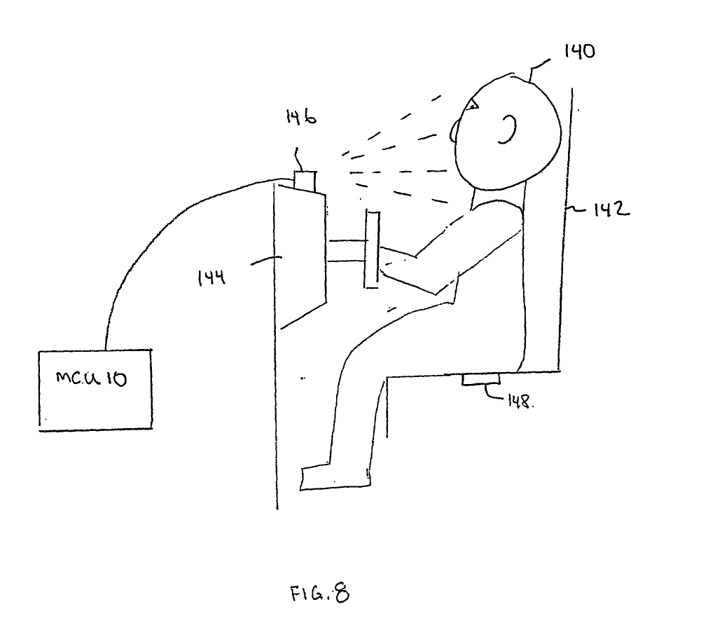

FIG. 8 shows another application for the MCU 10. An image sensor 146, such as a video camera, is located on a dashboard 144 of a vehicle. The camera 146 is coupled to one of the sensor interfaces 66 of the MCU 10 (see FIG. 3). The camera 146 is activated by any one of multiple different events. For example, the camera 146 may be activated when the driver 140 places a key into the car ignition. The camera 146 may also be activated when a pressure sensor 148 determines that someone is sitting in the seat 142 of the vehicle.

The camera 146 takes one or more pictures of the face and other features of the operator 140. If the facial image taken by the camera 146 is recognized by the MCU 10 as an authorized car operator, the MCU 10 enables the car ignition. The MCU 10 can also adjust other car devices related to the identified car operator 140.

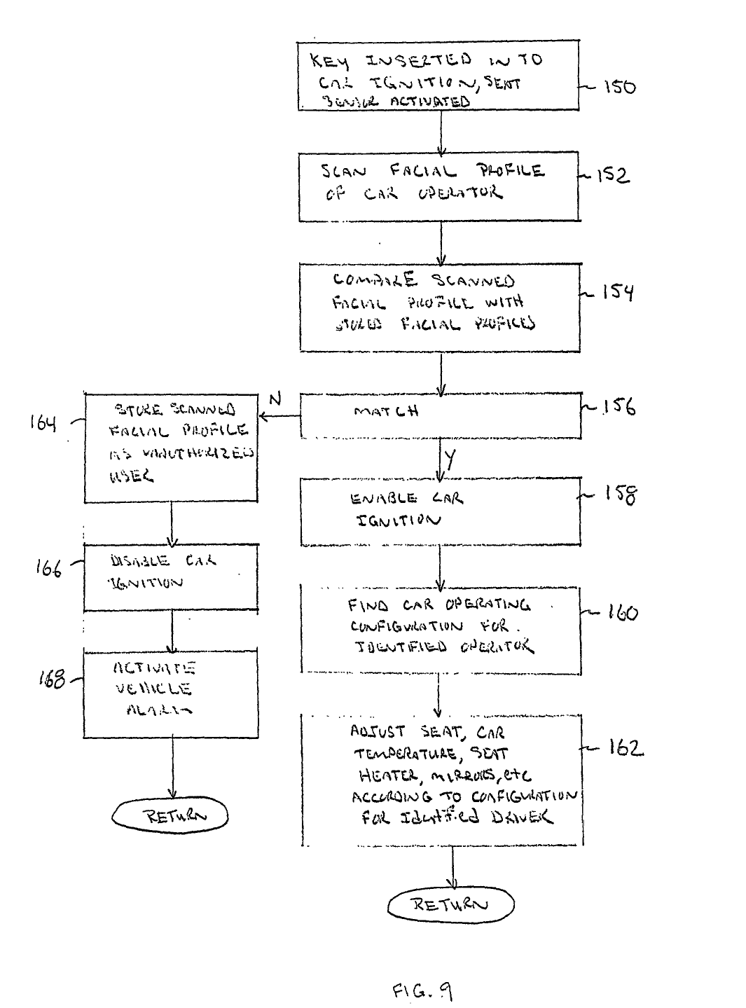

FIG. 9 shows in more detail how the facial image of the car operator is used to control car ignition and other car functions. In block 150, a car operator inserts a key into the car ignition, sits in the car seat, or does some other action that initiates the image sensor 146. The image sensor 146 scans a facial profile of the car operator 140 in block 152. The scanned profile in block 154 is then compared with prestored authorized facial images in MCU memory. The prestored authorized facial images can be loaded by first entering a password into the MCU 10 and then initiating a facial scan by selecting a facial scan command on the MCU display screen.

If there is no match between the scanned facial image and the prestored authorized facial images in block 156, the facial scan for the operator 140 is stored as an unauthorized user in block 164. This unauthorized user facial scan can then be downloaded by the car owner to determine the identity of the unauthorized user. The car ignition is also disabled by the MCU 10 in block 166. This may be done by activating a relay or wiring harness signal that connects power to the car ignition. Optionally, a car alarm may be automatically activated in block 168.

If there is a match between the scanned facial image of operator 140 and one of the prestored authorized facial images, then the car ignition is enabled in block 158. In block 160, the MCU 10 identifies any vehicle operating configuration files associated with the matching authorized facial image. For example, the persons associated with the prestored facial images may have selected certain customized vehicle adjustments. These adjustments are stored in a configuration file that is linked with their associated facial image. The MCU in block 162 automatically adjusts the car devices according to the identified configuration file. For example, seat height, seat heating, car temperature, mirror adjustments, etc. may all be automatically adjusted according to the configuration file associated with the matching facial image.

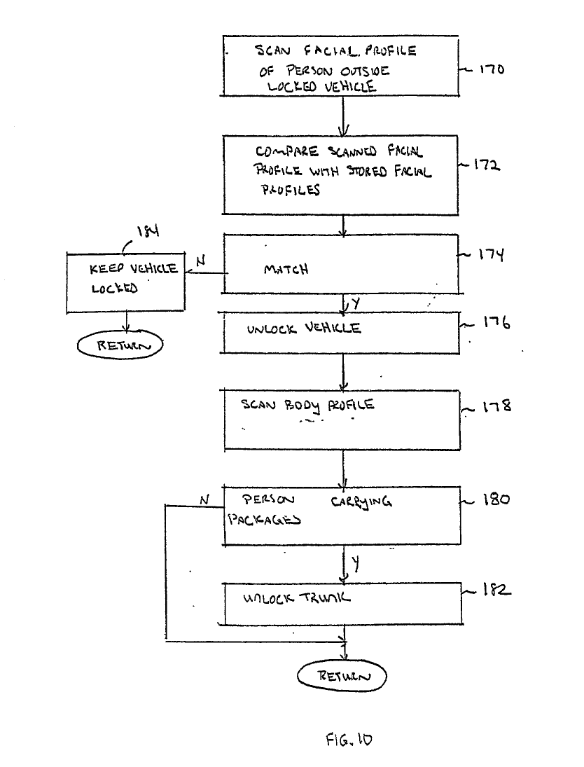

Referring to FIG. 10, the same or a different image sensor 146 as shown in FIG. 8 may point outside the vehicle. In block 170 the image sensor scans the facial profile of a person located outside the locked vehicle. The facial profile scan may be initiated manually by the person pushing a button on the vehicle or automatically when the person moves within some scanning range of the image sensor 146. The MCU in block 172 compares the facial profile scan with profiles of authorized vehicle operators stored in memory.

If there is no match in block 174, the vehicle remains locked in block 184. However, if there is a match in block 174, and the profile in memory matching the scanned profile has authorization to enter the vehicle, then the MCU unlocks the vehicle doors in block 176. Upon verifying an authorized vehicle operator, the MCU can also adjust different vehicle parameters associated with the identified vehicle operator as previously discussed in FIG. 9.

Additionally, the image sensor may scan an entire body profile of the person in block 178. If the body scan indicates the person is carrying a package in block 180, then the MCU automatically unlocks the vehicle trunk in block 182. This can be determined by identifying additional objects located next to the person that do not match a general human body profile.

The system described in FIG. 10 can also be used for rental car agencies. Instead of using car keys, the rental car customer can have their facial image digitally captured when checking into the rental car counter. The facial image can be transmitted wirelessly to a receiver in the rental car assigned to the customer. The facial image is then stored in the rental car memory as an authorized user.

Any time during the rental period the rental customer approaches their assigned vehicle, an image sensor in the rental car scans the facial image of the rental car customer. Since the scanned image matches one of the authorized images stored in memory, the rental car is automatically unlocked. After the rental car customer returns the vehicle to the rental car agency, or after some predetermined period of time after the rental car agreement has expired, the profile of the customer is erased from the MCU memory in the rental car.

For preferred rental car customers, other personal car preferences of the customer may also be downloaded to the MCU of the selected rental car, along with the facial profile. As soon as the rental car customer approaches the vehicle, the seat, rear view mirrors, radio, etc. will be automatically adjusted to the customer preferences.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred embodiment thereof, it should be apparent that the invention may be modified in arrangement and detail without departing from such principles. I claim all modifications and variation coming within the spirit and scope of the following claims.

1. A collision control unit, comprising:
a platform;
a collision detection sensor rigidly attached to the platform; and
a processor attached to the platform, the processor initiating different collision detection events when a collision condition is indicated by the collision detection sensor.

2. A collision control unit according to claim 1 wherein the platform is attachable and detachable inside a vehicle.

3. A collision control unit according to claim 1 wherein the platform is located in an interior passenger section or trunk section of the vehicle.

4. A collision control unit according to claim 1 wherein the platform is a piece of rigid metal.

5. A collision control unit according to claim 1 including an wiring harness interface for coupling signals from a vehicle wiring harness to the processor.

6. A collision control unit according to claim 5 wherein the wiring harness interface includes a wireless transceiver for wirelessly transmitting signals between the wiring harness and the processor.

7. A collision control unit according to claim 6 wherein the wiring harness interface comprises a J1850 connector.

8. A collision control unit according to claim 5 including a memory for storing vehicle parameters from the wiring harness during vehicle operation.

9. A collision control unit according to claim 8 wherein the memory also stores parameter profiles, the processor comparing with the stored vehicle parameters with the parameter profiles to identify failure or replacement conditions.

10. A collision control unit according to claim 1 including a wireless communication unit coupled to the processor for transmitting both voice and vehicle operating parameters to a call center.

11. A collision control unit according to claim 10 wherein the processor automatically activates the wireless communication unit to establish a call with the call center according to G forces detected by the collision detection sensor.

12. A collision control unit according to claim 11 wherein the processor receives control signals from the call center and controls different vehicle devices according to the received call center control signals.

13. A collision control unit according to claim 1 wherein the processor automatically disconnects a fuel line and disconnects a battery when G forces detected by the collision detection sensor indicate a collision condition.

14. A vehicle control unit, comprising:
an wiring harness interface for tapping into signals carried on a vehicle wiring harness; and
a main processor located in the vehicle and configured to monitor the signals from the wiring harness and control car operations real-time during vehicle driving according to the monitored wiring harness signals.

15. A vehicle control unit according to claim 14 including a Global Positioning System (GPS), the processor determining a kinematic state for the vehicle according to location data received from the GPS and speed data received from the wiring harness.

16. A vehicle control unit according to claim 14 including a hard drive for storing data from the wiring harness signals.

17. A vehicle control unit according to claim 14 including detection sensors coupled to a sensor fusion processor for identifying kinematic states for objects detected by the detection sensors.

18. A vehicle control unit according to claim 17 wherein the main processor compares kinematic states for objects detected by the sensor fusion processor with a kinematic state determined for the vehicle to identify potential collision conditions.

19. A vehicle control unit according to claim 14 including a collision detection sensor used by the main processor to identify collision conditions.

20. A vehicle control unit according to claim 19 including a wireless communication unit that is automatically used by the main processor to establish a wireless communication channel with a call center when collision conditions are identified.

21. A vehicle control unit according to claim 19 wherein the main processor automatically transmits signals from the wiring harness to the call center over the wireless communication channel.

22. A vehicle control unit according to claim 21 wherein the wireless communication unit automatically establishes a voice channel between the vehicle and the call center when collision conditions are identified.

23. A vehicle control unit according to claim 20 wherein the call center sends control signals over the wireless channel back to the main processor for controlling vehicle functions remotely from the call center.

24. A vehicle control unit according to claim 14 including a wireless transceiver coupled to the wiring harness interface for wirelessly transmitting the wiring harness signals to the processor.

25. A vehicle control unit according to claim 19 including relays that are automatically activated by the main processor for disabling a battery and a fuel line and unlocking door locks when collision conditions are identified.

26. A vehicle control unit according to claim 14 wherein the processor stores wiring harness signals over time, compares the stored wiring harness signals with vehicle parameter profiles real-time while the vehicle is being driven, and identifies trends in the comparisons the indicate failures or replacement conditions of vehicle parameters.

27. A vehicle operator identification system, comprising:
an image sensor for capturing the facial image of an vehicle operator;
a memory configured to store profiles for authorized vehicle operators; and
a processor configured to compare the captured facial image with the stored profiles and enable vehicle operations according to the comparison.

28. A vehicle operator identification system according to claim 27 wherein the processor disables a car ignition system when there is no match between the captured facial image and the stored profiles.

29. A vehicle operator identification system according to claim 27 wherein the processor identifies a configuration file associated with one of the stored profiles matching the captured facial image and modifies vehicle devices according to the identified configuration file.

30. A vehicle operator identification system according to claim 29 wherein the configuration file includes seat adjustment parameters, car temperature parameters, mirror adjustment parameters, or door lock enable.

31. A vehicle operator identification system according to claim 27 including a pressure sensor for activating the image sensor when the vehicle operator sits in a vehicle seat.

32. A vehicle operator identification system according to claim 27 wherein the image sensor captures the facial image of a person located outside the vehicle and unlocks vehicle doors if the facial image of the person matches a profile stored in the memory.

33. A method for controlling access to a vehicle, comprising:
storing images of persons authorized to access the vehicle;
capturing an image of a person outside the vehicle;
comparing the captured image to the stored authorized images; and
unlocking a door on the vehicle if the captured image matches one of the stored authorized images.

34. A method according to claim 33 including:
capturing the image of a rental car customer at a rental car check-in station;
transmitting the captured image of the rental car customer to a rental car selected for the rental car customer; and
storing the captured image of the rental car customer in the selected rental car as one of the authorized images.

35. A method according to claim 34 including automatically deleting the image of the rental car customer from the authorized images when a rental period for the selected vehicle has expired.

36. A method according to claim 34 including storing a set of personal vehicle parameters associated with the rental car customer and transmitting the personal vehicle parameters to the selected rental car.

37. A method according to claim 36 including using the personal vehicle parameters to adjust any one of a rear view mirror, seat position, radio settings or temperature settings in the selected rental car.

38. A method according to claim 33 including;
using the captured image of the person to determine if the person is carrying packages; and
automatically unlocking a trunk of the vehicle if the captured image matches one of the stored authorized images and the captured image indicates the person is carrying packages.
